(19) United States
(12) Patent Application Publication
(10) Pub. No.: US 2022/0104928 A1
(43) Pub. Date: Apr. 7, 2022

(54) DENTAL MEASURING INSTRUMENT, MEASURING METHOD, AND ATTACHMENT INSTRUMENT

(71) Applicant: GRIN INC., Tokyo (JP)

(72) Inventor: Sadahiro HAYASHI, Tokyo (JP)

(21) Appl. No.: 17/422,327

(22) PCT Filed: Nov. 28, 2019
(86) PCT No.: PCT/JP2019/046521

§ 371 Date: Jul. 12, 2021

(30) Foreign Application Priority Data
Jan. 25, 2019 (JP) 2019-011339

(51) Int. Cl. A61C 19/05; A61C 11/08

(52) U.S. Cl. CPC A61C 19/05; A61C 11/08

(57) ABSTRACT

The present invention simply and accurately measures a position and an orientation of a jaw in an oral cavity of a patient in dental treatment. A dental measuring instrument includes a mounting fixture mounted in an oral cavity of a patient, an arm part connected to the mounting fixture, and extending from the mounting fixture toward outside of the oral cavity of the patient, and a tip part provided on a tip of the arm part, and the arm part is deformable so as to change a position and an orientation of the tip part.

### TECHNICAL FIELD

The present invention relates to a measuring instrument and a measuring method for measuring a position and an orientation of a jaw in an oral cavity when dental treatment is performed. The present invention claims priority to Japanese Patent Application No. 2019-011339, filed on Jan. 25, 2019, the contents of which are incorporated by reference herein in its entirety in designated states where the incorporation of documents by reference is approved.

### BACKGROUND ART

In dental treatment, it is important to accurately determine a position and an orientation of an upper jaw of a patient. For example, when a face of a patient is viewed from the front, it is ideal that a median line of a front tooth for prosthesis or orthodontics is parallel to and overlaps (is located in the middle of) a median line of a face of a patient in terms of countenance. However, generally, there are many cases where a position and an orientation of an upper jaw of a patient are not completely located in the middle with respect to a face. Therefore, when a position and an orientation of an upper jaw of a patient are not accurately determined, aesthetics (such as an appearance of a front tooth) and functionality (such as occlusion) after treatment may be affected.

Under present circumstances, a measurement of a position and an orientation of an upper jaw of a patient is performed by various methods, for example, by performing marking on a wax rim when a dental prosthesis is manufactured, and by using a complex measuring instrument such as a face bow. For example, PTL 1 is related to a face bow.

### CITATION LIST

### Patent Literature

PTL 1: JP 2015-002782A

### SUMMARY OF INVENTION

### Technical Problem

However, it is difficult for an operator to accurately put a mark of marking in an intended position, and there are many cases where an appropriate measurement result fails to be acquired. Further, a measuring instrument such as a face bow is often complex to operate, and there are many cases where an appropriate measurement result fails to be acquired due to difficulty and complexity of handling. When a measuring instrument is used, a result varies depending on which part of a face of a patient is used as a target for a measurement.

The present invention has been made in view of the above-mentioned problems, and an object of the present invention is to simply and accurately measure a position and an orientation of a jaw in an oral cavity of a patient in dental treatment including prosthesis, orthodontics, and an occlusal diagnosis.

### Solution to Problem

One aspect of the present invention that solves at least a part of the problems described above is a dental measuring instrument, and includes a mounting fixture mounted in an oral cavity of a patient, an arm part connected to the mounting fixture, and extending from the mounting fixture toward outside of the oral cavity of the patient, and a tip part provided on a tip of the arm part, wherein the arm part is deformable so as to change a position and an orientation of the tip part.

In the dental measuring instrument described above, the arm part may be configured to change a position and an orientation of the tip part in at least a straight direction corresponding to a left-right direction of the patient, a rotational direction corresponding to a direction about an axis in an up-down direction of the patient, and a rotational direction corresponding to a direction about an axis in a front-rear direction of the patient.

In any of the dental measuring instruments described above, the arm part may be detachable from the mounting fixture.

In any of the dental measuring instruments described above, the tip part may be detachable from the arm part.

In any of the dental measuring instruments described above, the mounting fixture may be a tray mounted on an upper jaw of the patient.

In any of the dental measuring instruments described above, the tip part may be a front tooth model.

In any of the dental measuring instruments described above, the front tooth model may be detachable from the arm part so as to be replaceable with another front tooth model.

In any of the dental measuring instruments described above, the tip part may be arranged outside the oral cavity of the patient, and include two parallel stick-shaped members.

In any of the dental measuring instruments described above, the tip part may be arranged outside the oral cavity of the patient, and include one stick-shaped member, and a target line may be displayed on a surface of the stick-shaped member along an axis direction of the stick-shaped member.

In any of the dental measuring instruments described above, the tip part may be arranged outside the oral cavity of the patient, and include a light emitter configured to emit one or two beams of planar light.

In any of the dental measuring instruments described above, the arm part may include at least one rotational mechanism, or at least one linear movement mechanism, or a mechanical structure of a combination of the rotational mechanism and the linear movement mechanism.

In any of the dental measuring instruments described above, a scale indicating a relative positional relationship between two members coupled via the rotational mechanism or the linear movement mechanism may be displayed on the two members.

In any of the dental measuring instruments described above, the mechanical structure may be provided on a connection part of the tip part to which the arm part is connected.

In any of the dental measuring instruments described above, the mechanical structure may be provided on a connection part of the mounting fixture to which the arm part is connected.

In any of the dental measuring instruments described above, a plurality of the tip parts may be provided, and the plurality of tip parts may be detachable from the arm part so as to be replaceable with each other.

In any of the dental measuring instruments described above, the arm part may be configured to detachably connect a plurality of arm members to each other, and each of the arm members may be detachable from the tip part or the mounting fixture so as to be replaceable with the other arm member.

In any of the dental measuring instruments described above, the arm part may include a member, including a wire, configured to be flexibly deformed and hold a shape.

Another aspect of the present invention that solves at least a part of the problems described above is an attachment instrument for making a dental measuring instrument conform to a second dental instrument other than the attachment instrument, the dental measuring instrument including a mounting fixture mounted in an oral cavity of a patient, an arm part connected to the mounting fixture, and extending from the mounting fixture toward outside of the oral cavity of the patient, and a tip part provided on a tip of the arm part, the arm part being deformable so as to change a position and an orientation of the tip part, the attachment instrument including: a support member connected to the second dental instrument, and extending from the second dental instrument; and a holding member supported by a tip of the support member, and configured to hold the dental measuring instrument.

In the attachment instrument described above, the support member may be deformable so as to change a position of the holding member.

In any of the attachment instruments described above, the second dental instrument may be an articulator configured to fix the mounting fixture of the dental measuring instrument.

In any of the attachment instruments described above, the second dental instrument may be a pedestal or a jig configured to fix the mounting fixture of the dental measuring instrument.

A still another aspect of the present invention that solves at least a part of the problems described above is a dental measuring instrument, and the dental measuring instrument includes an arm part detachably connected to a mounting fixture mounted in an oral cavity of a patient, or a portion of the mounting fixture located outside the oral cavity of the patient, and extending toward the outside of the oral cavity of the patient or toward the patient, and a tip part provided on a tip of the arm part, wherein the arm part is deformable so as to change a position and an orientation of the tip part.

A still another aspect of the present invention that solves at least a part of the problems described above is a measuring method, and the measuring method includes preparing a dental measuring instrument including a mounting fixture mounted in an oral cavity of a patient, an arm part connected to the mounting fixture, and extending from the mounting fixture toward the outside of the oral cavity of the patient, and a tip part provided on a tip of the arm part, the arm part being deformable so as to change a position and an orientation of the tip part, mounting the mounting fixture in the oral cavity of the patient, changing the position and the orientation of the tip part by deforming the arm part, removing the mounting fixture from the patient, and acquiring a difference in position and orientation of the arm part or the tip part before and after deformation of the arm part.

A still another aspect of the present invention that solves at least a part of the problems described above is a dental measuring instrument, and the dental measuring instrument includes a mounting fixture mounted in an oral cavity of a patient, and a front tooth model detachable from the mounting fixture.

In the dental measuring instrument described above, at least one of the front tooth model and the mounting fixture includes a movable part configured to hold in a changeable manner for at least one of a position and an orientation of the front tooth model.

### Advantageous Effects of Invention

The present invention can simply and accurately measure a position and an orientation of a jaw in an oral cavity of a patient in dental treatment.

### BRIEF DESCRIPTION OF DRAWINGS

FIG. 1 is a diagram illustrating a schematic configuration example of a measuring instrument according to one embodiment of the present invention.

FIG. 2 is a diagram illustrating a configuration example of a mounting fixture.

FIG. 3 is a diagram illustrating a configuration example of an arm part.

FIG. 4 is a diagram illustrating another configuration example of the arm part.

FIG. 5 is a diagram illustrating various configuration examples of the measuring instrument.

FIG. 6 is a diagram illustrating a schematic configuration example of a measuring instrument according to one embodiment of the present invention.

FIG. 7 is a diagram illustrating an example of a relationship between a front tooth model and a jaw joint.

FIG. 8 is a diagram illustrating a configuration example of an articulator and an attachment instrument according to one embodiment of the present invention.

FIG. 9 is a diagram illustrating a configuration example of an attachment instrument according to one embodiment of the present invention for replacing a front tooth model with an artificial front tooth.

FIG. 10 is a diagram illustrating a configuration example of an operation instrument and an attachment instrument according to one embodiment of the present invention.

FIG. 11 is a diagram illustrating a configuration example of the operation instrument.

FIG. 12 is a diagram illustrating a schematic configuration example of a measuring instrument according to one embodiment of the present invention.

FIG. 13 is a diagram illustrating a schematic configuration example of a measuring instrument according to one embodiment of the present invention.

FIG. 14 is a diagram illustrating a schematic configuration example of a measuring instrument according to one embodiment of the present invention.

FIG. 15 is a diagram illustrating a schematic configuration example of a measuring instrument according to one embodiment of the present invention.

### DESCRIPTION OF EMBODIMENTS

A plurality of embodiments according to the present invention will be described below with reference to the drawings.

In the present specification, an X direction, a Y direction, and a Z direction in a measuring instrument substantially correspond to a left-right direction, an up-down direction, and a front-rear direction of a patient, respectively, for convenience of description. An x rotation, a y rotation, and a z rotation in the measuring instrument substantially correspond to a rotation about an axis in the left-right direction, a rotation about an axis in the up-down direction, and a rotation about an axis in the front-rear direction of a patient, respectively.

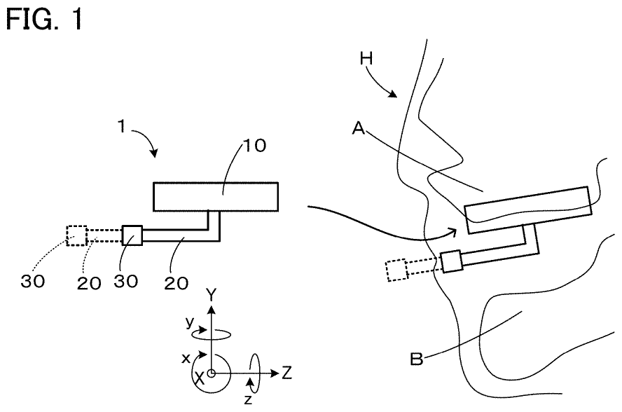

FIG. 1 is a diagram illustrating a schematic configuration example of a measuring instrument 1 according to one embodiment of the present invention. The measuring instrument 1 is a dental measuring instrument mounted on an upper jaw A in an oral cavity of a patient, and used for measuring a position and an orientation of the upper jaw A with respect to a head H of the patient. A position and an orientation of the upper jaw A are normally measured with reference to a median line of a face of the patient in terms of countenance. Note that the upper jaw includes both cases of a dentate jaw (row of teeth+alveolar ridge) and an edentate jaw (only alveolar ridge).

The measuring instrument 1 includes, as a main component, a mounting fixture 10, an arm part 20, and a tip part 30. The mounting fixture 10 is a member mounted on the upper jaw A. The arm part 20 is a member that is connected in certain position and orientation (position and orientation in an initial state) to the mounting fixture 10, and extends toward the outside of an oral cavity while the mounting fixture 10 is mounted on the upper jaw A. The tip part 30 is a member that is provided in certain position and orientation on a tip (on an opposite side to the mounting fixture 10) of the arm part 20, and serves as a mark for a measurement.

The arm part 20 has a deformable structure such that a position and an orientation (posture) of the tip part 30 can be changed. The tip part 30 may be arranged inside the oral cavity and may be arranged outside the oral cavity while the mounting fixture 10 is mounted on the upper jaw A. At least a position X, an orientation y, and an orientation z among six axes (positions XYZ and orientations xyz) of the tip part 30 can be changed from an initial state by deforming the arm part 20.

A measurer such as a dentist mounts the mounting fixture 10 on the upper jaw A of the patient by using a hand, for example. Then, the measurer adjusts a position and an orientation (at least Xyz) of the tip part 30 such that a median line of the tip part 30 is parallel to and overlaps (is located in the middle of) a median line of the head H in terms of countenance when a face of the patient is viewed from the front. The position and the orientation of the tip part 30 (i.e., a position and an orientation of the upper jaw A with respect to the head H of the patient) after the adjustment are saved (stored) in the measuring instrument 1 via a shape of the arm part 20. Note that the position X, the orientation y, and the orientation z are particularly important information among positions and orientations of the upper jaw A with respect to the head H of the patient. For example, in conventional marking, a mark indicating the orientation y cannot be left, and it is difficult to accurately provide marks indicating the position X and the orientation z.

By measuring a difference between a position and an orientation of a reference (initial state) of the arm part 20 before an adjustment and a position and an orientation after the adjustment, and converting the difference into a numerical form, the position and the orientation being saved can be expressed as a numerical value. As a technique of conversion into a numerical form, for example, a scale indicating a positional relationship between two members that relatively move among a plurality of members constituting the deformable structure of the arm part 20 is displayed (by printing, carving, bonding, and the like) on the two members. A difference in scale between the two members can be acquired by a visual inspection and image processing by a computer program. For example, a position and an orientation before and after an adjustment of the arm part 20 and/or the tip part 30 can be read by a 3D scanner, and a difference in the position and the orientation before and after reading by image processing by a computer program can be calculated.

The mounting fixture 10 can include various aspects. The mounting fixture 10 is, for example, a tray (may also be referred to as a plate and the like) mounted on an upper jaw. The tray includes a personal (customized) tray manufactured by impression taking, and an existing tray that can be used by a plurality of patients. Furthermore, there are a tray mounted via an impression material and a bite taking material, and a tray mounted without using an impression material and a bite taking material. The impression taking may be performed by using an impression material and the like, and may be performed by optically scanning the inside of an oral cavity.

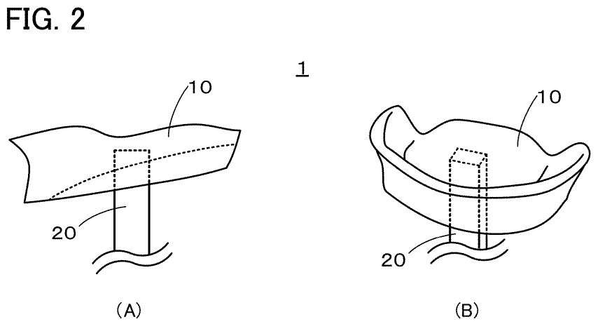

FIG. 2 is a diagram illustrating a configuration example of the mounting fixture 10, and (A) of FIG. 2 illustrates a side view and (B) of FIG. 2 illustrates a perspective view. FIG. 2 illustrates the mounting fixture 10 that is a personal tray.

The deformable structure of the arm part 20 is not particularly limited as long as a position and an orientation of the tip part 30 can be changed, but the deformable structure of the arm part 20 can be achieved by a combination of various mechanical elements such as a rotational mechanism (such as a joint and a rotational shaft) and a linear movement mechanism (such as a slide mechanism and an extension/contraction mechanism), for example.

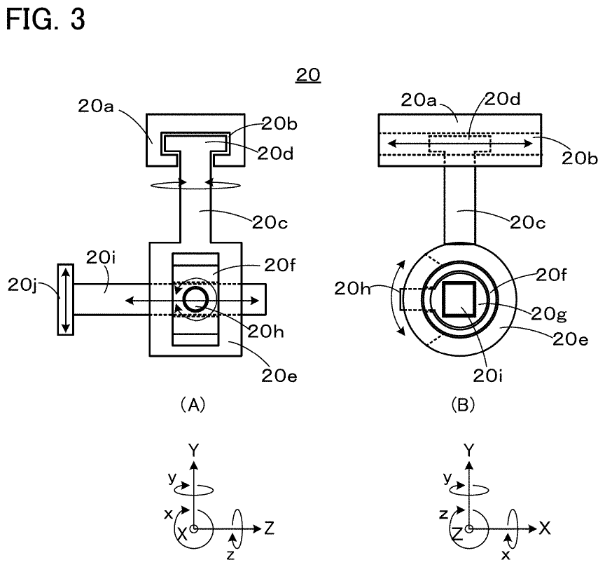

FIG. 3 is a diagram illustrating a configuration example of the arm part 20, and (A) of FIG. 3 illustrates a side view and (B) of FIG. 3 illustrates a back view. The arm part 20 illustrated in FIG. 3 can move the tip part 30 in the XYZ directions and rotates the tip part 30 in the xyz rotations.

The arm part 20 is formed of a member 20a, a member 20c, a member 20f, a member 20g, a member 20i, and a member 20j.

The member 20a is fixed to the mounting fixture 10. A guide groove 20b extending in the X direction is formed in the member 20a. An engagement member 20d having a disc shape held in the guide groove 20b is provided at one end of the member 20c extending in the Y direction. The engagement member 20d engages with the guide groove 20b, and thus the member 20c can move in the X direction and make the y rotation.

A holding member 20e that holds the member 20f is provided at another end of the member 20c. A columnar hollow extending in the Z direction is formed in the holding member 20e. The member 20f has a cylindrical shape. The member 20f is held in the hollow of the holding member 20e, and thus the member 20f can make the z rotation.

The member 20g is spherical, and an engagement member 20h protruding and having a columnar shape is provided on a surface of the member 20g. A through hole through which the engagement member 20h is inserted is provided in the member 20f. While the engagement member 20h is inserted through the through hole of the member 20f, the member 20g is held in the hollow of the member 20f, and thus the member 20g can make the x rotation. Note that a long guide hole is formed about the z-axis in a wall of the holding member 20e so as to expose the engagement member 20h penetrating the member 20f.

A prismatic hollow extending in the Z direction is formed in the member 20g. The member 20i has a prismatic shape. The member 20i engages with and is held in the hollow of the member 20g, and thus the member 20i can move in the Z direction.

The member 20j is connected to one end of the member 20i. A recessed part and a protruding part (or a protruding part and a recessed part) that engage with each other so as to be movable relatively in the Y direction are formed on the member 20i and the member 20j. In this way, the member 20j is movable in the Y direction. Note that the tip part 30 is fixed to the member 20j.

Note that members constituting the arm part 20 engage with each other with moderate friction so as to be able to statically maintain the arm part 20 in each posture by changing the arm part 20 to various shapes. Of course, a fixing member such as a screw mechanism may be provided on a coupling portion between at least some members so as to be able to fix/release a movement relative to each other.

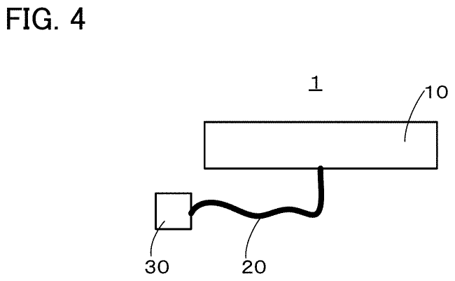

At least a part of the arm part 20 may be achieved without a mechanical structure. FIG. 4 is a diagram illustrating another configuration example of the arm part 20. The arm part 20 is formed of a member that can be flexibly deformed and can hold a shape, such as a wire, for example. In this case, a position and an orientation of the tip part 30 can be changed more freely than those in the mechanical structure as in FIG. 3. The mechanical structure and the flexible member may be combined.

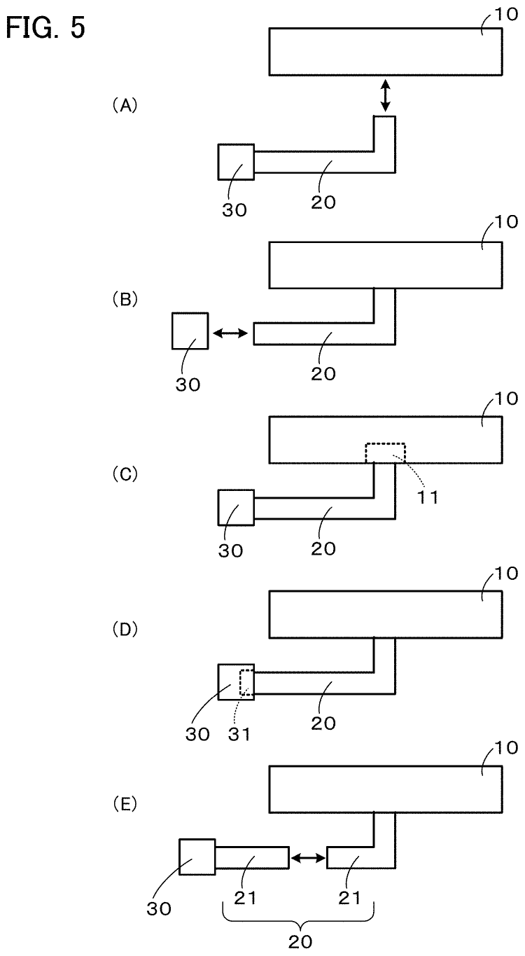

The measuring instrument 1 is not limited to the configuration as described above. FIG. 5 is a diagram illustrating various configuration examples of the measuring instrument 1. One or more of the configuration examples may be combined.

As illustrated in (A) of FIG. 5, the mounting fixture 10 and the arm part 20 may be configured to be detachable. The detachable structure is not particularly limited, but can be, for example, a fitting structure of a male and a female, a male screw and a female screw, a metal and a magnet, magnets, and the like. In this way, the mounting fixture 10 can be easily replaced from the arm part 20 (or the arm part 20 can be easily replaced from the mounting fixture 10).

As illustrated in (B) of FIG. 5, the arm part 20 and the tip part 30 may be configured to be detachable. The detachable structure is not particularly limited, but can be, for example, a fitting structure of a male and a female, a male screw and a female screw, a metal and a magnet, magnets, and the like. In this way, the arm part 20 can be easily replaced from the tip part 30 (or the tip part 30 can be easily replaced from the arm part)

As illustrated in (C) of FIG. 5, a mechanical element (a movable part 11) that can change at least one of positions and orientations (at least one of XYZxyz) of the arm part 20 may be provided on a portion of the mounting fixture 10 to which the arm part 20 is connected. The mechanical element is, for example, a rotational mechanism (such as a joint and a rotational shaft), a linear movement mechanism (such as a slide mechanism and an extension/contraction mechanism), and the like as described above. In this way, the mechanical structure can be simplified by reducing the number of shafts of the arm part 20. The arm part 20 may not have a deformable structure. Note that it is important that a position and an orientation of the tip part 30 can be changed, and thus the movable part 11 may be interpreted as a part of the arm part 20.

As illustrated in (D) of FIG. 5, a mechanical element (a movable part 31) that can change at least one of positions and orientations (at least one of XYZxyz) of the arm part 20 may be provided on a portion of the tip part 30 to which the arm part 20 is connected. The mechanical element is, for example, a rotational mechanism (such as a joint and a rotational shaft), a linear movement mechanism (such as a slide mechanism and an extension/contraction mechanism), and the like as described above. In this way, the mechanical structure can be simplified by reducing the number of shafts of the arm part 20. The arm part 20 may not have a deformable structure. Note that it is important that a position and an orientation of the tip part 30 can be changed, and thus the movable part 31 may be interpreted as a part of the arm part 20.

As illustrated in (E) of FIG. 5, the arm part 20 is formed of two arm members 21 that may be separable and detachable from each other. Of course, the arm part 20 may be formed of three or more arm members 21. Each of the arm members 21 is configured so as to include a movable shaft different from the other arm member 21. For example, a first arm member 21 takes charge of Xyz, and a second arm member 21 takes charge of xYZ. Any of the arm members 21 may not include a movable shaft. Each of the arm members 21 may be detachable from the mounting fixture 10 or the tip part 30. Each of the arm members 21 may be replaceable with the other arm member 21.

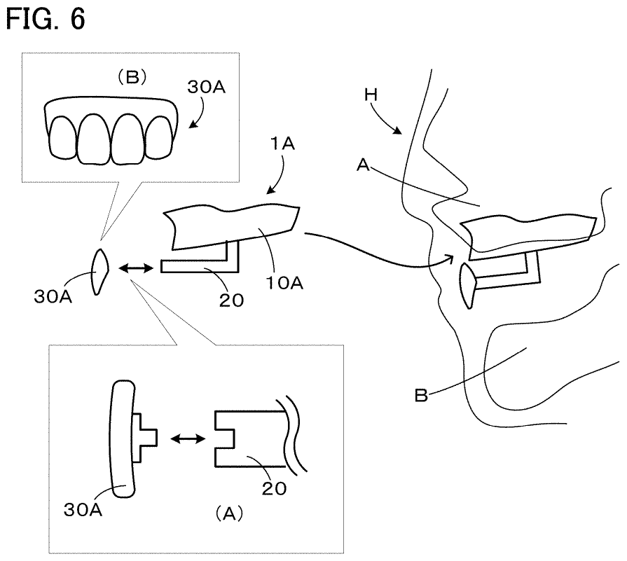

FIG. 6 is a diagram illustrating a schematic configuration example of a measuring instrument 1A according to one embodiment of the present invention. The measuring instrument 1A is basically used for a patient whose upper jaw is an edentate jaw, but can also be used for a patient with a dentate jaw (without a part of teeth). The measuring instrument 1A includes a personal tray 10A as the mounting fixture 10, an arm part 20, and a front tooth model 30A as the tip part 30.

As illustrated in (A) of FIG. 6, the front tooth model 30A is detachable in certain position and orientation from the tip of the arm part 20. The detachable mechanism can be, for example, a fitting structure of a male and a female, a male screw and a female screw, a metal and a magnet, magnets, and the like.

As illustrated in (B) of FIG. 6, the front tooth model 30A includes, for example, four front teeth and a gum portion around the teeth. For the front tooth model 30A, a plurality of models having different features such as a shape, a color, and a size of a tooth, a set of teeth, and a color of a gum, for example, are prepared and can be replaced. Of course, the front tooth model 30A is not limited to the illustrated number of teeth and may not include a gum portion. The front tooth model 30A may be configured such that a front tooth is detachable from a gum portion, and a front tooth or a gum portion may be replaceable with another front tooth or another gum portion. The detachable mechanism is as described above.

The personal tray 10A is manufactured by performing impression taking on the upper jaw A in advance. A root of the arm part 20 is fixedly connected or detachably connected in certain position and orientation to the personal tray 10A. For example, a measurer mounts the selected front tooth model 30A on the tip of the arm part 20, and mounts the personal tray 10A on the upper jaw A of a patient. Note that the personal tray 10A may temporarily adhere or be pressed with a hand or an instrument such that the personal tray 10A does not come off the upper jaw A.

Then, the measurer operates and deforms the arm part 20 to adjust a position and an orientation of the front tooth of the front tooth model 30A to be appropriate in terms of countenance of the patient. When the front tooth model 30A does not suit preferences of the patient or countenance of the patient, the front tooth model 30A may be replaced.

Subsequently, when a position and an orientation of the front tooth are determined, the measurer removes the personal tray 10A from the upper jaw A of the patient. In this way, a position and an orientation of the front tooth model 30A with respect to the upper jaw A of the patient (i.e., a position and an orientation of the upper jaw A with respect to the head H of the patient) are saved in the measuring instrument 1A via a shape of the arm part 20.

When the position and the orientation saved in the measuring instrument 1A are scheduled to be transferred to an articulator (dental instrument), and the like, the measurer may further measure a relative position of a front tooth with respect to a jaw joint of the patient while the measuring instrument 1A is mounted on the upper jaw A.

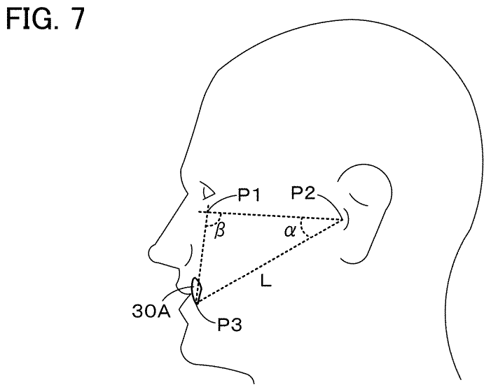

FIG. 7 is a diagram illustrating an example of a relationship between the front tooth model 30A and a jaw joint. FIG. 7 illustrates a case where an articulator with reference to a Frankfurt plane is used. P1 indicates a point of an infraorbital margin being a front reference, P2 indicates a point of an external auditory canal upper edge being a rear reference point, and P3 indicates a tip point of a front tooth of the front tooth model 30A.

The measurer measures a length L of a line segment P2P3 by using a ruler, a tape measure, and the like, for example. The measurer measures an angle α of the line segment P2P3 with respect to a line segment P2P1 (a side of the Frankfurt plane) by using a protractor and the like, for example. The length L and the angle a are values to be transferred to the articulator. Furthermore, an inclination angle β of the front tooth with respect to the line segment P2P1 may be measured by using a protractor and the like, for example. The angle β is also a value that may be transferred to the articulator.

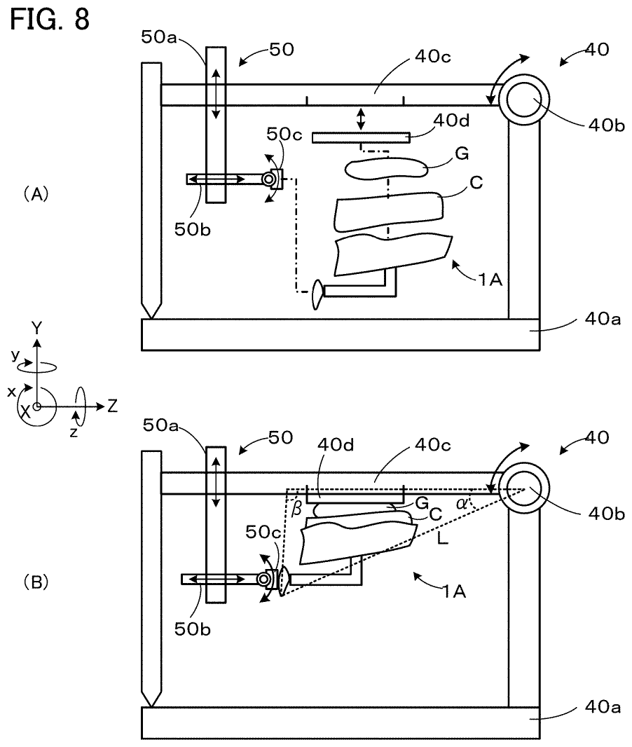

FIG. 8 is a diagram illustrating a configuration example of an articulator 40 and an attachment instrument 50 according to one embodiment of the present invention, and (A) of FIG. 8 illustrates a state before the measuring instrument 1A is mounted on the articulator 40 and (B) of FIG. 8 illustrates a state after the measuring instrument 1A is mounted on the articulator 40.

The articulator 40 includes a lower bow part 40a corresponding to a lower jaw, a joint part 40b corresponding to a head of mandible, and an upper bow part 40c corresponding to an upper jaw. The upper bow part 40c is connected so as to be able to open and be closed with respect to the lower bow part 40a via the joint part 40b. The articulator 40 includes a pedestal 40d (for example, referred to as a mounting plate and the like) that is detachable in certain position and orientation from the upper bow part 40c by a magnet and the like. An upper jaw model C of a patient adheres and is fixed to the pedestal 40d via a fixing material G such as adhesive gypsum. The upper jaw model C is manufactured by performing impression taking on the upper jaw A in advance.

The attachment instrument 50 can be mounted on the upper bow part 40c. The attachment instrument 50 is an instrument for mounting the measuring instrument 1A on the articulator 40 and making the measuring instrument 1A conform to the articulator 40. The attachment instrument 50 is formed of a member 50a, a member 50b, and a member 50c. The member 50a and the member 50b correspond to a support member, and the member 50c corresponds to a holding member.

The member 50a has a stick shape elongated in the Y direction, and is held so as to be movable in the Y direction with respect to the upper bow part 40c. The member 50b has a stick shape elongated in the Z direction, and is held on a lower side of the member 50a so as to be movable in the Z direction. The member 50c is held on a tip part of the member 50b so as to be able to make the x rotation. The member 50c can detachably hold the front tooth model 30A of the measuring instrument 1A in certain position and orientation. The detachable mechanism can be, for example, clips that sandwich the front tooth model 30A, a holder that holds the front tooth model 30A, a metal and a magnet, magnets, and the like.

An operator such as a dental technician mounts the pedestal 40d on the upper bow part 40c. The operator mounts, on the upper jaw model C of a patient, the personal tray 10A of the measuring instrument 1A that finishes a measurement for the patient, and further mounts the front tooth model 30A on the member 50c.

Then, the operator deforms the attachment instrument 50 (moves the member 50a in the up and down direction and moves the member 50b in the front and rear direction) such that a line segment connecting the joint part 40b and the tip point of the front tooth of the front tooth model 30A coincides with the measured length L, and an angle formed between the line segment and the upper bow part 40c also coincides with the measured angle α. Furthermore, when the angle β is measured, the operator deforms the attachment instrument 50 (rotates the member 50c) such that an inclination angle of the front tooth coincides with the measured angle β.

While the attachment instrument 50 is deformed as described above, the operator fills the fixing material G, such as adhesive gypsum, between the upper jaw model C and the pedestal 40d, and fixes the upper jaw model C to the pedestal 40d. After the upper jaw model C is fixed, the attachment instrument 50 may be removed from the front tooth model 30A and the articulator 40.

In this way, the measured L, α, and β can be transferred to the articulator 40. Since a position and an orientation of the front tooth model 30A with respect to the upper jaw A of the patient (i.e., a position and an orientation of the upper jaw A with respect to the head H of the patient) are saved in the measuring instrument 1A, the position and the orientation can also be transferred onto the articulator 40.

Subsequently, in order to manufacture a wax model denture by using the personal tray 10A mounted on the articulator 40, for example, an occlusion rim (wax rim) needs to be provided on the personal tray 10A and an artificial front tooth needs to be implanted in the occlusion rim. At this time, it is desirable that the artificial front tooth is implanted in the same position and orientation as those of the front tooth model 30A.

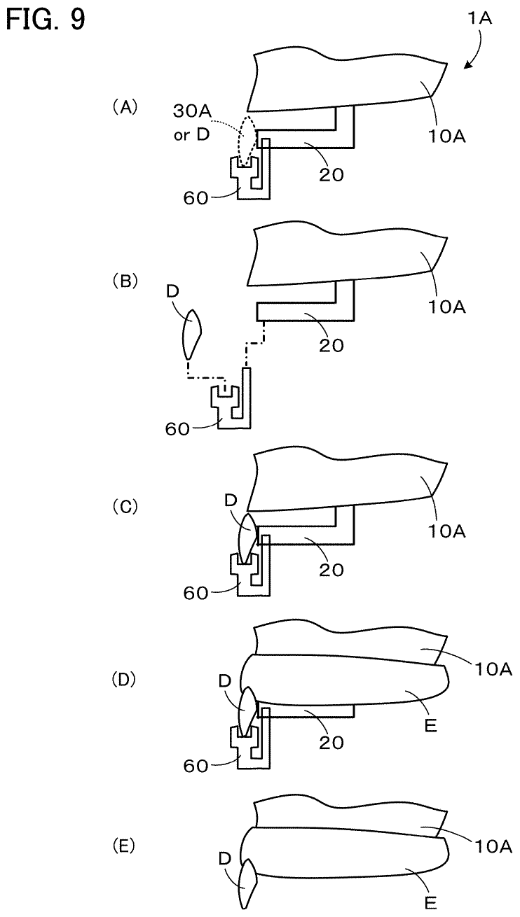

FIG. 9 is a diagram illustrating a configuration example of an attachment instrument 60 according to one embodiment of the present invention for replacing the front tooth model 30A with an artificial front tooth D.

The attachment instrument 60 can be detachably held on the tip of the arm part 20. The detachable mechanism can be, for example, a fitting structure, a metal and a magnet, magnets, and the like. The attachment instrument 60 held on the arm part 20 can hold the front tooth model 30A while maintaining a position and an orientation of the front tooth model 30A mounted on the arm part 20. In the example of FIG. 9, the attachment instrument 60 is configured to sandwich the front tooth model 30A from below. In other words, when the attachment instrument 60 holds the artificial front tooth D having the same shape instead of the front tooth model 30A, the attachment instrument 60 can hold the artificial front tooth D in the same position and orientation as those of the front tooth model 30A.

First, an operator removes the front tooth model 30A from the arm part 20, and removes the attachment instrument 60 from the arm part 20 ((A) and (B) of FIG. 9). Then, the operator causes the attachment instrument 60 to hold the artificial front tooth D, and mounts the attachment instrument 60 on the arm part 20 ((B) and (C) of FIG. 9). In this way, the artificial front tooth D is held, on the arm part 20, in the same position and orientation as those of the front tooth model 30A. Note that a material such as an impression material may fill the attachment instrument 60, the front tooth model 30A may be held on the impression material to perform impression taking, and the artificial front tooth D may fit in the mold.

Then, the operator provides a wax rim E on the personal tray 10A, and implants a root portion of the artificial front tooth D in the wax rim E ((D) of FIG. 9). Lastly, the operator removes the arm part 20 from the personal tray 10A and the wax rim E ((E) of FIG. 9). In this way, a wax model denture formed of the personal tray 10A, the wax rim E, and the artificial front tooth D is manufactured.

The measuring instrument 1A can be mounted on the other operation instrument (dental instrument) in addition to the pedestal 40d of the articulator 40. The other operation instrument is, for example, a pedestal and a jig for an operation while the mounting fixture 10 and the upper jaw model C on which the mounting fixture 10 is mounted are fixed. The operation instrument for fixing the upper jaw model C is referred to as a model pedestal and the like. The mounting fixture 10 and the upper jaw model C may be fixed to the operation instrument by using the fixing material G and an adhesive material.

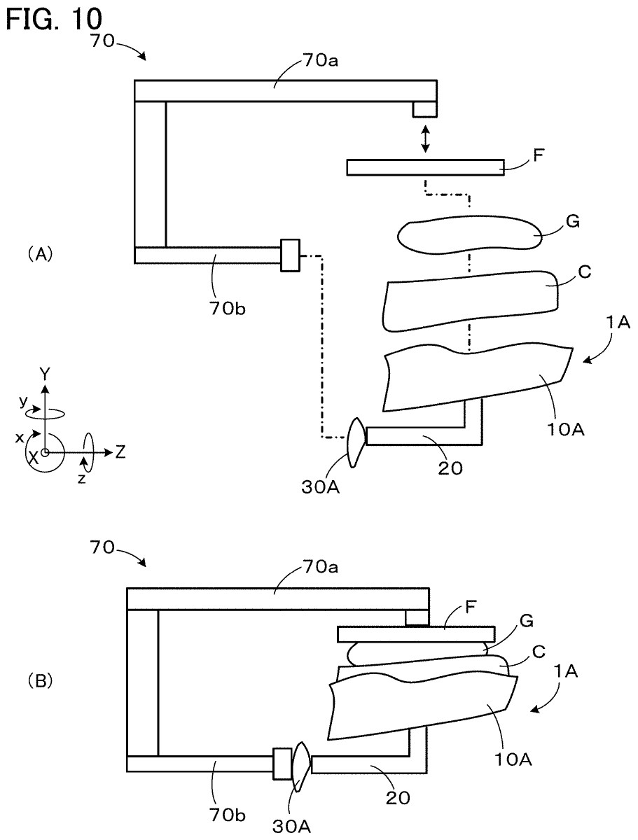

FIG. 10 is a diagram illustrating a configuration example of an operation instrument F and an attachment instrument 70 according to one embodiment of the present invention, and (A) of FIG. 10 illustrates a state before the measuring instrument 1A is mounted on the operation instrument F and (B) of FIG. 10 illustrates a state after the measuring instrument 1A is mounted on the operation instrument F.

The attachment instrument 70 is an instrument for mounting the measuring instrument 1A on the operation instrument F and making the measuring instrument 1A conform to the operation instrument F. The attachment instrument 70 is formed of a member 70a and a member 70b. In the example in FIG. 10, the member 70a and the member 70b are each a stick-shaped member and are connected to each other. The member 70a corresponds to a support member, and the member 70b corresponds to a holding member.

The member 70a can detachably hold the operation instrument F in certain position and orientation. The detachable mechanism can be, for example, clips that sandwich the operation instrument F, a holder that holds the operation instrument F, a metal and a magnet, magnets, and the like.

The member 70b can detachably hold the front tooth model 30A in certain position and orientation. The detachable mechanism can be, for example, clips that sandwich the front tooth model 30A, a holder that holds the front tooth model 30A, a metal and a magnet, magnets, and the like.

An operator mounts the operation instrument F on the member 70a. The operator mounts, on the upper jaw model C of a patient, the personal tray 10A of the measuring instrument 1A that finishes a measurement for the patient, and further mounts the front tooth model 30A on the member 70b.

Then, the operator fills the fixing material G, such as adhesive gypsum, between the upper jaw model C and the operation instrument F, and fixes the upper jaw model C to the operation instrument F. Lastly, the operator removes the attachment instrument 70 from the operation instrument F and the front tooth model 30A.

In this way, since a position and an orientation of the front tooth model 30A with respect to the upper jaw A of the patient (i.e., a position and an orientation of the upper jaw A with respect to the head H of the patient) are saved in the measuring instrument 1A, the position and the orientation can be transferred onto the operation instrument F.

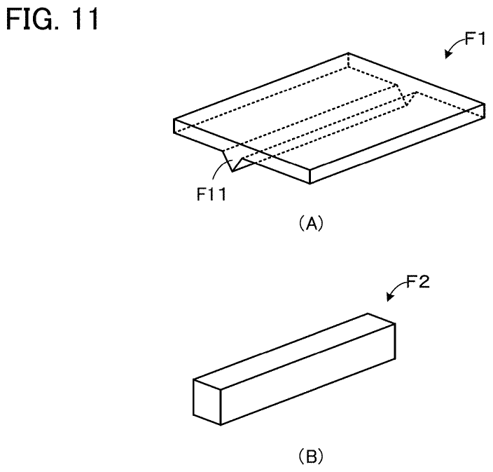

FIG. 11 is a diagram illustrating a configuration example of the operation instrument F.

An operation instrument F11 illustrated in (A) of FIG. 11 is formed in a plate shape, and one of surfaces is a flat surface, and a protruding part F11 that linearly extends is formed on a central part of another surface. The operation instrument F1 is mounted on the member 70a such that the surface including the protruding part F11 faces the upper jaw model C, for example. In this way, a trace corresponding to a shape of the surface including the protruding part F11 is formed on the upper jaw model C and/or the fixing material G. The formed trace can be used for determining a position and an orientation when the upper jaw model C is mounted on the operation instrument F1 or another operation instrument F1 again. Note that it can be said that a position and an orientation of the upper jaw A with respect to the head H of the patient are transferred to the position and the orientation of the trace.

An operation instrument F2 illustrated in (B) of FIG. 11 is formed in a prismatic shape. For example, the operation instrument F2 is mounted on the member 70a, and is implanted in the upper jaw model C and/or the fixing material G. Note that it can be said that a position and an orientation of the upper jaw A with respect to the head H of the patient are transferred to the position and the orientation of the operation instrument F2 implanted in the upper jaw model C and/or the fixing material G.

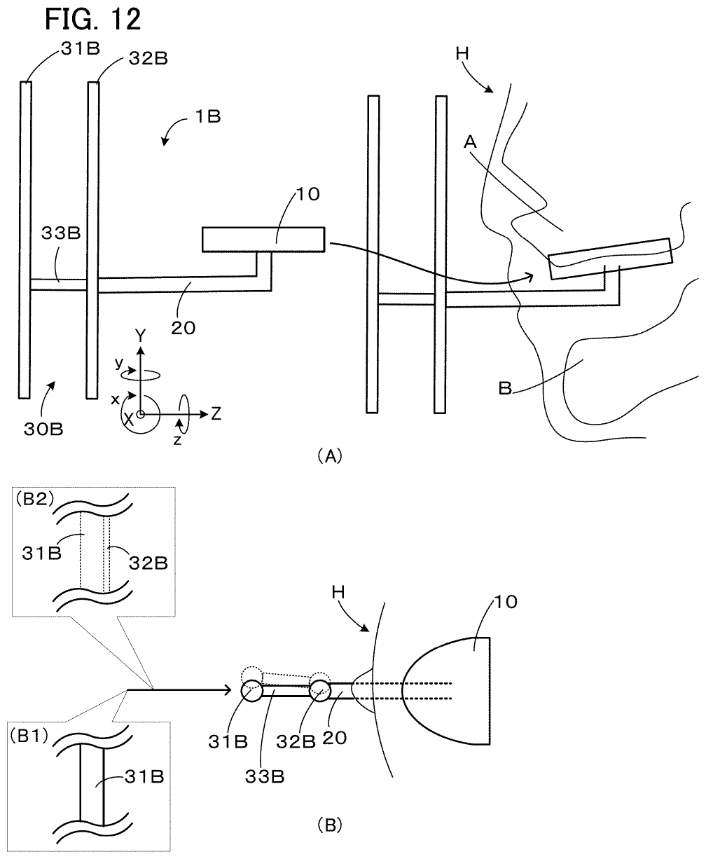

FIG. 12 is a diagram illustrating a schematic configuration example of a measuring instrument 1B according to one embodiment of the present invention, and (A) of FIG. 12 is a side view and (B) of FIG. 12 is a plan view. The measuring instrument 1B can be used when an upper jaw is a dentate jaw and an edentate jaw.

The measuring instrument 1B includes a mounting fixture 10, an arm part 20, and a tip part 30B. A tip side of the arm part 20 is located in front of a face outside an oral cavity while the measuring instrument 1B is mounted on a patient.

As illustrated in (A) and (B) of FIG. 12, the tip part 30B includes two parallel stick-shaped members 31B and 32B and a coupling member 33B. The stick-shaped member 32B is connected in the Y direction orthogonally to the arm part 20 extending in the Z direction. The coupling member 33B couples the two stick-shaped members 31B and 32B in the Z direction with an interval. The stick-shaped member 31B is connected in the Y direction orthogonally to the coupling member 33B extending in the Z direction. The stick-shaped member 31B and the stick-shaped member 32B are parallel to each other, and, when the measuring instrument 1B is viewed from the Z direction, the stick-shaped member 31B and the stick-shaped member 32B overlap each other.

For example, a measurer mounts the mounting fixture 10 on the upper jaw A of the patient, imagines an ideal median line of the head H while viewing the face of the patient from the front with one eye, and adjusts a position and an orientation of the tip part 30B such that the median line is hidden by the tip part 30B. At this time, an adjustment is made such that the stick-shaped member 32B and the median line are hidden behind the stick-shaped member 31B. (B1) of FIG. 12 illustrates a state where the adjustment is completed, and (B2) of FIG. 12 illustrates a state where the adjustment is not completed.

A position and an orientation of the tip part 30B (i.e., a position and an orientation of the upper jaw A with respect to the head H of the patient) after the adjustment are saved in the measuring instrument 1B via a shape of the arm part 20. As described above, the saved position and orientation can be acquired as a numerical value. With the measuring instrument 1B, the tip part 30B can be accurately located in the middle. Particularly, a position X and an orientation z can be accurately adjusted by using an axis of the stick-shaped member 31B in the Y direction, and an orientation y can be accurately adjusted by using overlapping between the stick-shaped member 31B and the stick-shaped member 32B.

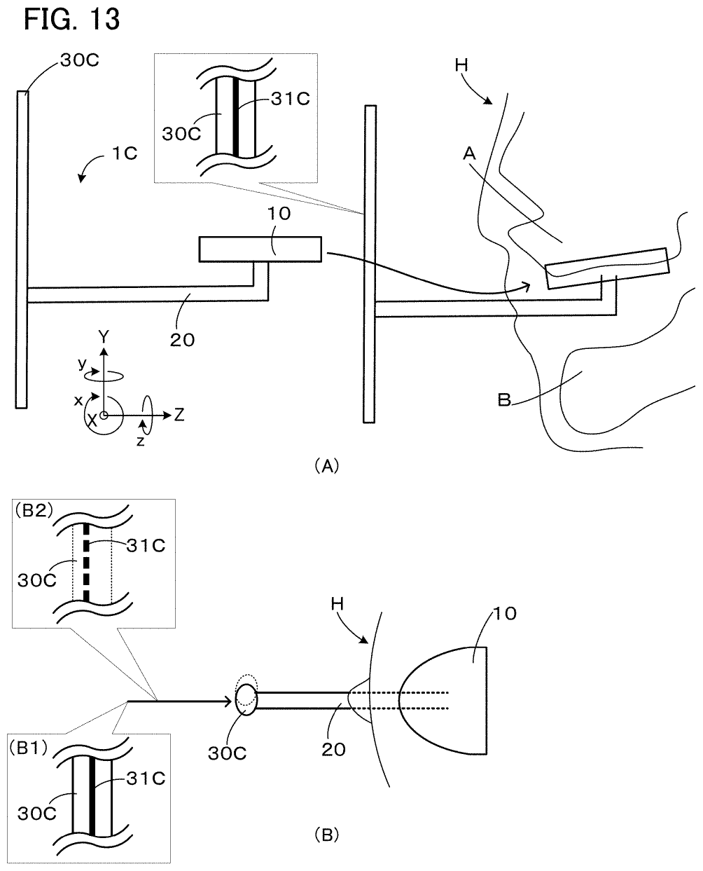

FIG. 13 is a diagram illustrating a schematic configuration example of a measuring instrument 1C according to one embodiment of the present invention, and (A) of FIG. 13 is a side view and (B) of FIG. 13 is a plan view. The measuring instrument 1C can be used when an upper jaw is a dentate jaw and an edentate jaw.

The measuring instrument 1C includes a mounting fixture 10, an arm part 20, and a stick-shaped member 30C as a tip part. A tip side of the arm part 20 is located in front of a face outside an oral cavity while the measuring instrument 1C is mounted on a patient.

As illustrated in (A) and (B) of FIG. 13, the stick-shaped member 30C is connected in the Y direction orthogonally to the arm part 20 extending in the Z direction. A target line 31C extending in the Y direction is displayed at the center of a surface of the stick-shaped member 30C on an opposite side to the arm part 20. When the measuring instrument 1C is viewed from the Z direction, the target line 31C is located at the center of the stick-shaped member 30C.

For example, a measurer mounts the mounting fixture 10 on the upper jaw A of the patient, imagines an ideal median line of the head H while viewing the face of the patient from the front with one eye, and adjusts a position and an orientation of the stick-shaped member 30C such that the median line is hidden by the stick-shaped member 30C. At this time, an adjustment is made such that the median line is hidden behind the stick-shaped member 30C and the target line 31C is visible at the center of the stick-shaped member 30C. (B1) of FIG. 13 illustrates a state where the adjustment is completed, and (B2) of FIG. 13 illustrates a state where the adjustment is not completed.

A position and an orientation of the stick-shaped member 30C (i.e., a position and an orientation of the upper jaw A with respect to the head H of the patient) after the adjustment are saved in the measuring instrument 1C via a shape of the arm part 20. As described above, the saved position and orientation can be acquired as a numerical value. With the measuring instrument 1C, the stick-shaped member 30C as the tip part can be accurately located in the middle. Particularly, a position X and an orientation z can be accurately adjusted by using an axis of the stick-shaped member 30C in the Y direction, and an orientation y can be accurately adjusted by using a position of the target line 31C with respect to the stick-shaped member 30C.

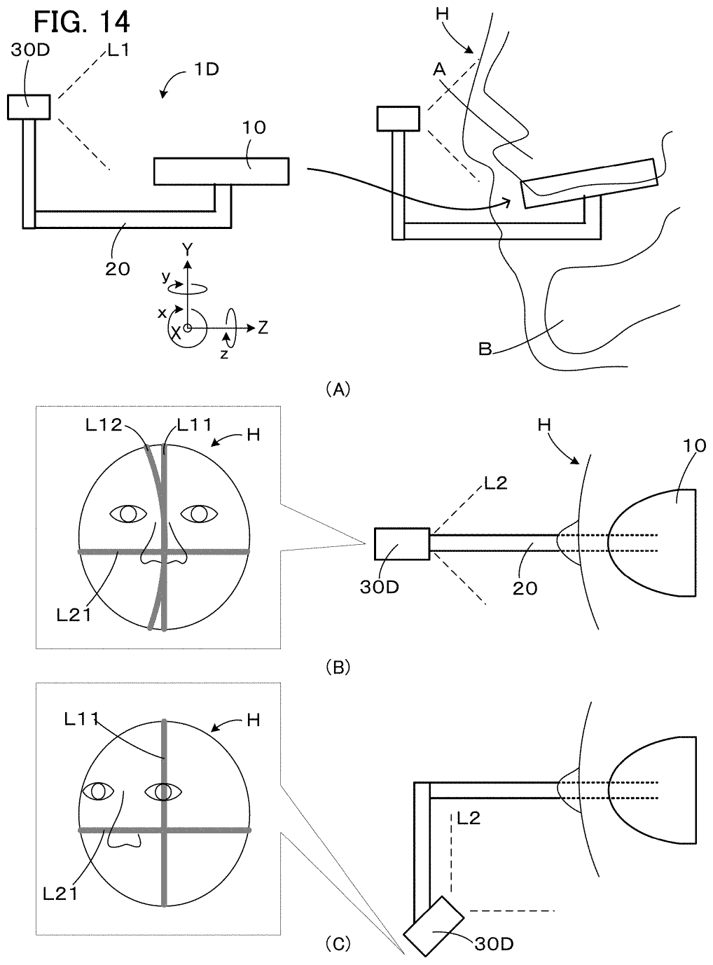

FIG. 14 is a diagram illustrating a schematic configuration example of a measuring instrument 1D according to one embodiment of the present invention, and (A) of FIG. 14 is a side view and (B) and (C) of FIG. 14 are plan views. The measuring instrument 1D can be used when an upper jaw is a dentate jaw and an edentate jaw.

The measuring instrument 1D includes a mounting fixture 10, an arm part 20, and a light emitter 30D as a tip part. A tip side of the arm part 20 is located in front of a face outside an oral cavity while the measuring instrument 1D is mounted on a patient.

As illustrated in FIG. 14, the light emitter 30D is connected to the arm part 20 extending in the Z direction via a coupling member having a stick shape. The light emitter 30D is, for example, a laser light emitter, and emits planar light L1 on a YZ plane. The light emitter 30D may emit planar light L2 on a XZ plane in addition to the light L1.

For example, a measurer mounts the mounting fixture 10 on the upper jaw A of the patient, imagines an ideal median line of the head H while viewing the face of the patient from the front, and adjusts a position and an orientation of the light emitter 30D such that a projection line by the light L1 overlaps the median line. Here, the projection line appears along a surface of the face, and thus an orientation y can be accurately adjusted. When the light L1 is incident from the front of the head H and is located in the middle (an adjustment of a position X, an orientation y, and an orientation z is completed), the projection line appears as a straight line at the center of the face of the patient (L11 in FIG. 14). On the other hand, when the light L1 is incident from the front of the head H and is not located in the middle (an adjustment of at least the orientation y is not completed), the projection line appears as a curved line on the face of the patient (L12 in FIG. 14). The projection line L12 in FIG. 14 illustrates a case where the light L1 is projected slightly toward a left direction.

The measurer may further imagine a reference plane (such as a Frankfurt plane) of the head H, and adjust an orientation (x) of the light emitter 30D such that the projection line by the light L2 is parallel to one side when the reference plane is viewed from the side (L21 in FIG. 14).

Note that the light emitter 30D may not only be arranged so as to emit light straight to the front of the face as illustrated in (B) of FIG. 14, but may also be arranged so as to diagonally emit light from a position shifted from the front of the face in the left-right direction as illustrated in (C) of FIG. 14. As in (C) of FIG. 14, the projection line by the light L2 can be clearly projected onto a side surface of the head H. Furthermore, the light emitter 30D may be arranged so as to emit light straight from the side surface of the face. In this way, the projection line by the light L2 can be more clearly projected onto a side surface of the head H.

A position and an orientation of the light emitter 30D (i.e., a position and an orientation of the upper jaw A with respect to the head H of the patient) after the adjustment are saved in the measuring instrument 1D via a shape of the arm part 20. As described above, the saved position and orientation can be acquired as a numerical value. With the measuring instrument 1D, the light emitter 30D as the tip part can be more accurately located in the middle. Particularly, a position X, an orientation z, and an orientation y can be accurately adjusted by using a projection line of the light L1 in the Y direction. Since the projection line of the light L1 appears along a surface of a face, an adjustment can be more accurately made than that at a distance from a face like the stick-shaped member illustrated in FIGS. 12 and 13.

According to the plurality of embodiments of the present invention described above, a position and an orientation of a jaw in an oral cavity of a patient can be simply and accurately measured in dental treatment.

Note that the front tooth model 30A is held on the attachment instrument when a transfer is performed in the embodiment illustrated in FIG. 8, but the present invention is not limited to such a method. For example, the attachment instrument is configured to be able to detachably hold a tip portion of the arm part 20 in certain position and orientation. An operator removes the front tooth model 30A from the arm part 20, and then mounts the tip portion of the arm part 20 on the attachment instrument. In this case, α, L, and β of the tip portion of the arm part 20 may be measured and used. Such a method is also applicable to the embodiment illustrated in FIG. 10. The method is also applicable when a transfer is performed for the measuring instrument in each of other embodiments (for example, FIGS. 12 to 14).

In each of the embodiments described above, the mounting fixture 10 is, for example, a tray, which is not limited thereto. The mounting fixture 10 may be, for example, an existing measuring instrument for tracing a Gothic arch. The mounting fixture 10 may also be, for example, a tray combined with an existing measuring instrument.

In each of the embodiments described above, a root of the arm part 20 is arranged inside an oral cavity, but may be arranged outside an oral cavity. For example, a part of the mounting fixture 10 may be arranged outside an oral cavity, and the arm part 20 may be connected to the portion. Further, for example, a root of the arm part 20 may be connected to a portion of an existing measuring instrument, such as a face bow as the mounting fixture 10, located outside an oral cavity. In this case, the arm part 20 may extend to the inside of the oral cavity of a patient, or may extend to the vicinity of the front of a face of the patient.

The tip part 30 may be configured such that a position and an orientation are easily distinguished in image processing when scanning is performed by a 3D scanner. For example, the tip part 30 is configured such that three axes orthogonal to each other are emphasized by a shape or a color.

The tip part 30 in each of the embodiments described above may be replaced with the tip part 30 in another embodiment and be used. Both of conversion into a numerical form by using a scale and conversion into a numerical form by using a 3D scanner may be used. A part of a position and an orientation (for example, Xyz) may be measured by using the measuring instrument 1, and at least a part of remaining axes (for example, xYZ) may be measured by a visual inspection and using a ruler.

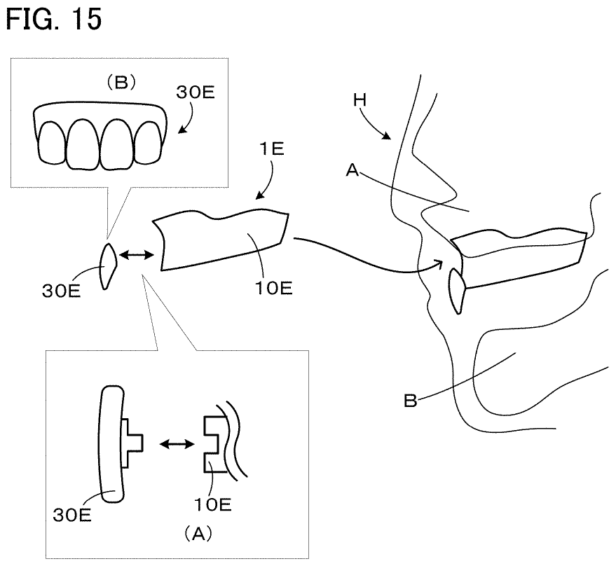

In the other embodiment, the arm part 20 may be omitted, and the tip part 30 may be connected to the mounting fixture 10. For example, a measuring instrument 1E illustrated in FIG. 15 includes a personal tray 10E as the mounting fixture 10 and a front tooth model 30E as the tip part 30. The front tooth model 30E is detachable in certain position and orientation from a surface of the personal tray 10E. The detachable mechanism can be, for example, a fitting structure of a male and a female, a male screw and a female screw, a metal and a magnet, magnets, and the like. At least one of the front tooth model 30E and the personal tray 10E may include a mechanical element (movable part) that changeably holds a position and an orientation of the front tooth model 30E. The front tooth model 30E can preferably change one or more of XYZxyz, and can preferably rotate at least the orientation z.

Note that the measuring instrument according to the embodiments of the present invention are more advantageous than a conventional measuring instrument in terms of operating efficiency and cost. Conventionally, for example, when a large and expensive measuring instrument such as a face bow is used, a face bow needs to be prepared for each patient, and the measured face bow need to be sent from a dental clinic to a dental technician's office. This is a disadvantage in terms of cost and operating efficiency.

On the other hand, the measuring instrument according to the embodiments of the present invention has a simpler structure than that of a face bow, and thus a plurality of the measuring instruments can be prepared at a low cost. By preparing, at a dental technician's office, a measuring instrument of the same kind as a measuring instrument used at a dental clinic, and sending a numerical value of a measurement result from the dental clinic to the dental technician's office by e-mail and letter, a position and an orientation of a tip part can also be reproduced, at the dental technician's office, in the measuring instrument of the same kind based on the numerical value. In this way, operating efficiency can be improved. Even when only the arm part separated from the measuring instrument is sent, cost reduction can be achieved.

The present invention is not limited to the plurality of embodiments described above, and various modified embodiments can be achieved within the scope of the gist of the present invention, and the present invention includes such aspects. A part of a component in a certain embodiment may be added to another embodiment or replaced with a part of component in another embodiment. A part of a component among components in a certain embodiment can also be omitted.

A configuration such as an arrangement, a dimension, and a shape of each component of an instrument such as a measuring instrument is not limited to the examples described or illustrated above as long as an object of the present invention can be achieved. Further, for example, words representing a relationship and a shape of a component, such as “orthogonal”, “perpendicular”, “horizontal”, and “parallel”, are used, but are not limited to literal strict meaning, and a case where a meaning is substantially the same as the meaning (i.e., a case where the effect of the present invention can be achieved) can also be included.

The present invention is not limited to a measuring instrument, and can be provided in various aspects such as a measuring method and a measuring system, for example. An instrument including a tip part, an arm part, and a mounting fixture is not limited to being referred to as a measuring instrument, and, for example, an instrument including a tip part and an arm part may be referred to as a measuring instrument.

### REFERENCE SIGNS LIST

1 Measuring instrument
1A Measuring instrument
1B Measuring instrument
1C Measuring instrument
1D Measuring instrument
1E Measuring instrument
10 Mounting fixture
10A Personal tray
10E Personal tray
11 Movable part
20 Arm part
20a Member
20b Guide groove
20c Member
20d Engagement member
20e Holding member
20f Member
20g Member
20h Engagement member
20i Member
20j Member
21 Arm member
30 Tip part
30A Front tooth model
30B Tip part
30C Stick-shaped member
30D Light emitter
30E Front tooth model
31 Movable part
31B Stick-shaped member
31C Target line
32B Stick-shaped member
33B Coupling member
40 Articulator
40a Lower bow part
40b Joint part
40c Upper bow part
40d Pedestal
50 Attachment instrument
50a Member
50b Member
50c Member
60 Attachment instrument
70 Attachment instrument
70a Member
70b Member
A Upper jaw
B Lower jaw
C Upper jaw model
D Artificial front tooth
E Wax rim
F Operation instrument
F1 Operation instrument
F2 Operation instrument
F11 Protruding part
G Fixing material
H Head
L1 Light
L2 Light

1. A dental measuring instrument comprising:
a mounting fixture mounted in an oral cavity of a patient;
an arm part connected to the mounting fixture, and extending from the mounting fixture toward outside of the oral cavity of the patient; and
a tip part provided on a tip of the arm part, wherein
the arm part is deformable so as to change a position and an orientation of the tip part.

2. The dental measuring instrument according to claim 1, wherein
the arm part is configured to change a position and an orientation of the tip part in at least a straight direction corresponding to a left-right direction of the patient, a rotational direction corresponding to a direction about an axis in an up-down direction of the patient, and a rotational direction corresponding to a direction about an axis in a front-rear direction of the patient.

3. The dental measuring instrument according to claim 1, wherein
the arm part is detachable from the mounting fixture.

4. The dental measuring instrument according to claim 1, wherein
the tip part is detachable from the arm part.

5. The dental measuring instrument according to claim 1, wherein
the mounting fixture is a tray mounted on an upper jaw of the patient.

6. The dental measuring instrument according to claim 5, wherein
the tip part is a front tooth model.

7. The dental measuring instrument according to claim 6, wherein
the front tooth model is detachable from the arm part so as to be replaceable with another front tooth model.

8-9. (canceled)

10. The dental measuring instrument according to claim 1, wherein
the tip part is arranged outside the oral cavity of the patient, and includes a light emitter configured to emit one or two beams of planar light.

11. The dental measuring instrument according to claim 1, wherein
the arm part includes at least one rotational mechanism, or at least one linear movement mechanism, or a mechanical structure of a combination of the rotational mechanism and the linear movement mechanism.

12. The dental measuring instrument according to claim 11, wherein
a scale indicating a relative positional relationship between two members coupled via the rotational mechanism or the linear movement mechanism is displayed on the two members.

13. The dental measuring instrument according to claim 11, wherein
the mechanical structure is provided on a connection part of the tip part to which the arm part is connected.

14. The dental measuring instrument according to claim 11, wherein
the mechanical structure is provided on a connection part of the mounting fixture to which the arm part is connected.

15. The dental measuring instrument according to claim 1, wherein
a plurality of the tip parts are provided, and
the plurality of tip parts are detachable from the arm part so as to be replaceable with each other.

16. The dental measuring instrument according to claim 1, wherein
the arm part is configured to detachably connect a plurality of arm members to each other, and
each of the arm members is detachable from the tip part or the mounting fixture so as to be replaceable with the other arm member.

17-22. (canceled)

23. A measuring method comprising:
preparing a dental measuring instrument including a mounting fixture mounted in an oral cavity of a patient, an arm part connected to the mounting fixture, and extending from the mounting fixture toward the outside of the oral cavity of the patient, and a tip part provided on a tip of the arm part, the arm part being deformable so as to change a position and an orientation of the tip part;
mounting the mounting fixture in the oral cavity of the patient;
changing the position and the orientation of the tip part by deforming the arm part;
removing the mounting fixture from the patient; and
acquiring a difference in position and orientation of the arm part or the tip part before and after deformation of the arm part.

24. A dental measuring instrument comprising:
a mounting fixture mounted in an oral cavity of a patient; and
a front tooth model detachable from the mounting fixture.

25. The dental measuring instrument according to claim 24, wherein
at least one of the front tooth model and the mounting fixture includes a movable part configured to hold in a changeable manner for at least one of a position and an orientation of the front tooth model.
